(19) United States
(12) Patent Application Publication
(10) Pub. No.: US 2026/0326877 A1
(43) Pub. Date: Oct. 22, 2026

(54) CONTROL SYSTEM AND METHOD FOR CONTROLLING HYBRID MARINE VESSELS

(71) Applicant: Caterpillar Inc., Peoria, IL (US)

(72) Inventors: Merritt CALLAGHAN, St. Louis (CA); Brian P. NEATHERY, Hockley, TX (US); Sai Pranav PASUPULETI, Houston, TX (US); Kraig M. LOVE, Washington, IL (US)

(73) Assignee: Caterpillar Inc., Peoria, IL (US)

(21) Appl. No.: 19/185,780

(22) Filed: Apr. 22, 2025

(51) Int. Cl. B63H 21/21; B63B 45/00; B63H 21/20; G06F 3/02

(52) U.S. Cl. CPC B63H 21/21; B63B 45/00; B63H 21/20; B63B 2201/00; B63H 2021/205; B63H 2021/216; G06F 3/02

(57) ABSTRACT

A propulsion system for a marine vessel includes a first driveline assembly, comprising: a first engine; a first motor; and a first propulsion device configured to be driven by the first engine or the first motor; a second driveline assembly, comprising: a second engine; a second motor; and a second propulsion device configured to be driven by the second engine or the second motor; and a control station comprising: an interactive user interface; and an engine mode activator switch. A user interaction with the engine mode activator switch initiates an engine mode activation display on the interactive user interface, the engine mode activation display including an option to initiate a split engine mode operation.

### TECHNICAL FIELD

The present disclosure generally relates to marine vessels and more particularly, to a control system and method for controlling operations of the marine vessels.

### BACKGROUND

Marine propulsion systems come in a variety of forms. Conventional marine propulsion systems utilize an engine that turns a propeller via a shaft. Other marine propulsion systems may include two propellers, each including a driveline assembly comprising a respective shaft driven by a hybrid of an engine and an electrical motor. Furthermore, each may include a generator connected to the motor in a system for providing power to the propeller and other mechanical and electrical components of a marine craft. These systems provide fuel economy via the interplay among the mechanical and electrical components and can be operated in a variety of operating modes.

The complexity in the number of operating modes available for powering the marine propulsion system require controls and user interfaces that are easy to use and are designed to encourage fuel efficient operation. The controls and user interfaces should also allow users opportunities for customizable control of the marine propulsion systems. For example, users may identify a need to operate either a starboard side or port side propeller via an internal combustion engine, while the other of the starboard side or port side propeller remains idle. A need exists to allow for users to access and operate in modes that include split mode engine operation, while also encouraging the use of hybrid and fuel-efficient modes.

U.S. Patent Application Publication No. 2024/0067323, published on Feb. 29, 2024 (“the '323 publication”), describes a steering system for a ship to which left and right propulsors are attached. The steering system of the '323 publication includes a first input device configured to receive an input of any one of a forward thrust parameter and a reverse thrust parameter of the propulsors, a second input device configured to receive an input of the other of the forward thrust parameter and the reverse thrust parameter of the propulsors, and a controller configured to reflect the forward thrust parameter and the reverse thrust parameter to the propulsors in real time. However, the '323 publication does not disclose that the left and right propulsors each include a driveline assembly comprising a respective shaft configured to be driven by a hybrid of an engine and an electrical motor.

The systems and methods of the present disclosure may solve one or more of the problems set forth above or other problems in the art. The scope of the current disclosure, however, is defined by the attached claims, and not by the ability to solve any specific problem.

### SUMMARY

In one aspect, a propulsion system for a marine vessel may include a first driveline assembly, comprising: a first engine; a first motor; and a first propulsion device configured to be driven by the first engine or the first motor; a second driveline assembly, comprising: a second engine; a second motor; and a second propulsion device configured to be driven by the second engine or the second motor; and a control station comprising: an interactive user interface; and an engine mode activator switch. A user interaction with the engine mode activator switch may initiate an engine mode activation display on the interactive user interface, the engine mode activation display including an option to initiate a split engine mode operation.

In another aspect, a user interactive interface for a propulsion system of a marine vessel comprising a first propulsion device and a second propulsion device may include: a display; an activator switch; and one or more buttons configured to select options generated on the display. A user interaction with the activator switch may initiate an engine mode activation display on the display, the engine mode activation display including an option to initiate a split engine mode operation whereby: (i) the first propulsion device is driven by a first engine and the second propulsion device is idle; or (ii) the second propulsion device is driven by a second engine and the first propulsion device is idle.

In another aspect, a method for controlling operations of a marine vessel having a first engine and a second engine operable to propel the marine vessel may include: receiving a first user input to activate a start control of one or more of the first engine and the second engine; generating, on a display of an interactive user interface, an option to activate one or more of the first engine and the second engine; receiving, at the display of the interactive user interface, a second user input to activate one or more of the first engine and the second engine; transmitting, from the interactive user interface to a propulsion control unit, the second user input; and generating, at the propulsion control unit based on the second user input, one or more operating signals for operating the first engine or the second engine.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic representation of a marine propulsion system, according to aspects of the disclosure.

FIG. 2 provides a flowchart depicting an exemplary method for operating a marine propulsion system, according to aspects of the disclosure.

FIG. 3 illustrates exemplary user interfaces displayed on an operator console, according to aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

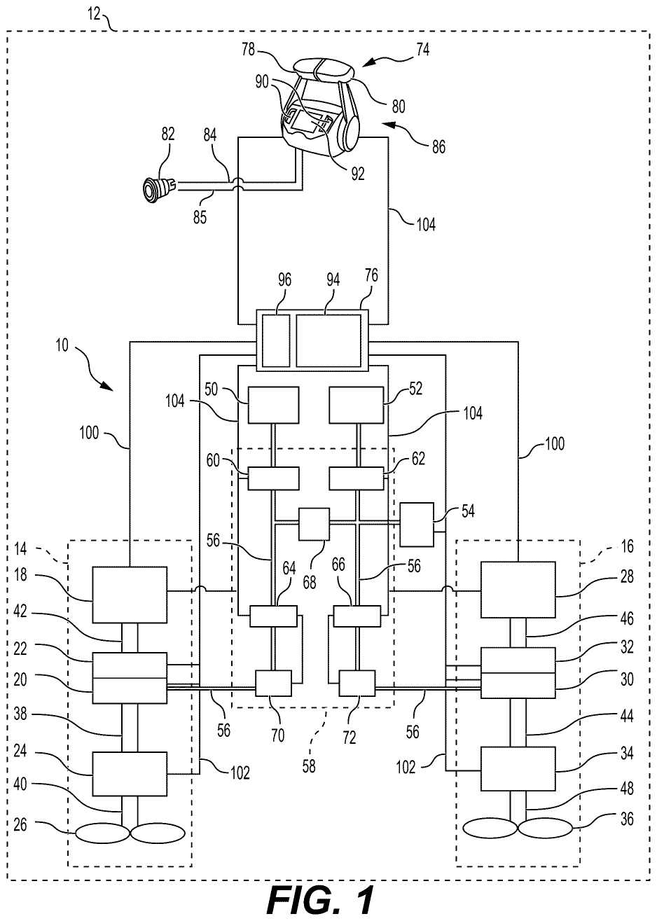

FIG. 1 illustrates an exemplary embodiment of a marine propulsion system 10 for a marine vessel. In the illustrated embodiment, the marine propulsion system 10 is a parallel propulsion system having a first driveline assembly 14 (port side assembly) and a second driveline assembly 16 (starboard side assembly) arranged in parallel with the first driveline assembly 14. The second driveline assembly 16 may be identical to the first driveline assembly 14 or may include one or more similar or the same components. In other embodiments, however, the marine propulsion system 10 may not be a parallel propulsion system or may include more or less than two driveline assemblies.

In the exemplary embodiment, the first driveline assembly 14 includes a first power source 18, a first motor-generator 20, a first clutch 22, a first gearbox 24, and a first propulsion device 26 arranged in series. In the illustrated embodiment, the second driveline assembly 16 includes the same components as the first driveline assembly 14. In other examples, first gearbox 24 may be optional. For example, gearboxes are not required when an azimuth thruster is used as a propulsion device. In the exemplary embodiment, the second driveline assembly 16 likewise includes a second power source 28, a second motor-generator 30, a second clutch 32, a second gearbox 34, and a second propulsion device 36 arranged in series. The description of the components of the first driveline assembly 14 applies equally to the second driveline assembly 16. In other embodiments, however, the second driveline assembly 16 may include one or more different components from the first driveline assembly 14.

The first driveline assembly 14 is configured such that the first power source 18 drives a first output shaft 38 that drives the first propulsion device 26. The first power source 18 may be any suitable power source capable of driving the first propulsion device 26. Suitable power sources may include, but not be limited to, reciprocating engines, such as diesel, gaseous (e.g. liquified natural gas), gasoline, or dual fuel engines, and turbines, such as steam, gas or nuclear-powered steam turbines. The size and configuration of the power source may also vary in different embodiments. In the illustrated embodiment, the first and the second power sources 18, 28 are internal combustion diesel engines.

The first propulsion device 26 may be configured in a variety of ways. In the illustrated embodiment, the first propulsion device 26 is a propeller, such as for example, a fixed pitch or controllable-pitch propeller that is connected to the other components of the first driveline assembly 14 by a first propeller shaft 40. The first propeller shaft 40 is connected to the first output shaft 38 by the first gearbox 24.

In the exemplary embodiment, the first power source 18 drives the first output shaft 38 via a first power source shaft 42 and a clutched connection to the first motor-generator 20 and the first output shaft 38. The first clutch 22 provides the clutched connection such that the first motor-generator 20 is fixed for rotation with the first output shaft 38, not with the first power source shaft 42. The first clutch 22 may be configured in a variety of ways. Any clutch that can selectively decouple the first power source shaft 42 from the first output shaft 38 and allow the first motor-generator 20 to drive the first output shaft 38 alone or in combination with the first power source 18 may be used. In other examples, first power source 18 may be directly coupled to first clutch 22, and the power source shaft 42 is located between the first clutch 22 and the first motor-generator 20.

The first motor-generator 20 may be configured in a variety of ways. Any suitable electric motor-generator capable of (i) driving the first propulsion device 26 or the second propulsion device 36 while operating as a motor and (ii) providing power to drive, or assist driving, the second motor-generator 30 while operating as a generator, may be used. The first motor-generator 20 may be a single integrated motor and generator or may be a separate motor and a separate generator.

Similar to the first driveline assembly 14, the second power source 28 drives a second output shaft 44 via a second power source shaft 46 and a clutched connection to the second motor-generator 30 and the second output shaft 44. The second propulsion device 36 may be a propeller connected to the other components of the second driveline assembly 16 by a second propeller shaft 48. The second propeller shaft 48 is connected to the second output shaft 44 by the second gearbox 34.

The marine propulsion system 10 may also include one or more electrical generation sets (“gensets”). In the illustrated embodiment, the marine propulsion system 10 includes a first genset 50 and a second genset 52. In other embodiments, however, the marine propulsion system 10 may include more or less than two gensets. In the exemplary embodiment, the first and the second gensets 50, 52 are diesel engine gensets.

The marine propulsion system 10 may also include an electrical storage device 54. Any device capable of storing and providing electrical power to the marine vessel 12 may be used. For example, the electrical storage device 54 may be one or more DC batteries.

The first driveline assembly 14, the second driveline assembly 16, the first genset 50, the second genset 52, and the electrical storage device 54 are electrically connected via an electrical grid of the marine vessel 12, as shown by lines 56 in FIG. 1. Thus, the electrical power provided by the first genset 50 or the electrical power provided by the second genset 52 can be directed to the first motor-generator 20, the second motor-generator 30, the electrical storage device 54, or some combination thereof. Likewise, the electrical power generated by the first motor-generator 20 or the second motor-generator 30, when in generating mode, can be directed to the electrical storage device 54 or to the other of the first or the second motor-generator 20, 30.

The electrical grid of the marine vessel 12 also electrically connects the first genset 50, the second genset 52, the first motor-generator 20, the second motor-generator 30, or the electrical storage device 54 to various electrical devices and ancillary electrical systems (not shown) of the marine vessel 12, such as lights, navigation equipment, air conditioning, and other electrical devices. Thus, the first genset 50, the second genset 52, the first motor-generator 20, the second motor-generator 30, and the electrical storage device 54 may be used, alone or in combination, to power the various electrical devices.

The marine propulsion system 10 may also include various electrical components 58 configured to facilitate the transfer of electrical power between various components of the marine propulsion system 10, such as for example, from the first and second gensets 50, 52 to the first and second motor-generators 20, 30 and the electrical storage device 54 and from the first motor-generator 20 to the second motor-generator 30 and vice versa. The number and type of electrical components 58 may differ in various embodiments of the marine propulsion system 10. The electrical components 58 may include, for example, a first rectifier 60 associated with the first genset 50 and a second rectifier 62 associated with the second genset 52 to convert the alternating current (AC) from the first and the second gensets 50, 52 to direct current (DC), respectively.

The electrical components 58 may also include a first bi-directional rectifier-inverter 64 (e.g., a variable frequency drive) associated with the first motor-generator 20 and a second bi-directional rectifier-inverter 66 associated with the second motor-generator 30 to convert the AC current from the first motor-generator 20 and the second motor-generator 30, when in generator mode, to direct current (DC), respectively. In some examples. the electrical components 58 may also include one or more DC filters 68, a first wye/delta switch 70 associated with the first motor-generator 20, and a second wye/delta switch 72 associated with the second motor-generator 30.

The marine propulsion system 10 also includes an operator control station 74, and a propulsion control unit 76 for the marine propulsion system 10. Any control device or devices capable of providing a signal indicative of the desired power output (e.g., 0-100% output) for a driveline assembly may be used for the operator control station 74. In some examples, the operator control station 74 may also include devices capable of providing a signal indicative of the desired directional output (e.g., forward or reverse). In some examples, the operator control station 74 may also include, for example, one or more levers, knobs, handles, joysticks, interactive displays, or other devices configured to receive operator input regarding the desired power output and directional output for the driveline assemblies.

In one exemplary embodiment, the operator control station 74 includes a first input device 78, such as a lever, for controlling the first driveline assembly 14 and a second input device 80, such as a lever, for controlling the second driveline assembly 16. Each of the first input device 78 and the second input device 80 are movable through a range between a first position indicative of 0% power output and a second position indicative of 100% power output for the first driveline assembly 14 and the second driveline assembly 16, respectively.

The operator control station 74 may also include one or more buttons, switches, toggles, or the like that allow the operator to select one or more operating modes for the marine propulsion system 10. For example, an engine activator switch, such as engine start/stop button 82 may be connected to operator control station 74, button 82 configured to start or stop power sources 18 and 28. The engine start/stop button 82 may be integrated into operator control station 74 or may be remotely connected via signal lines 84 and 85. The engine start/stop button 82 may be a tactile button and a normally closed contact. Having both normally open and normally closed contacts between the engine start/stop button 82 and the operator control station 74 provides safety and avoids unintentional switching ON of the power sources 18 and 28.

The operator control station 74 is communicatively coupled to the propulsion control unit 76, as shown by lines 104 in FIG. 1, to provide signals to the propulsion control unit 76 regarding the desired mode of operation of each of the driveline assemblies.

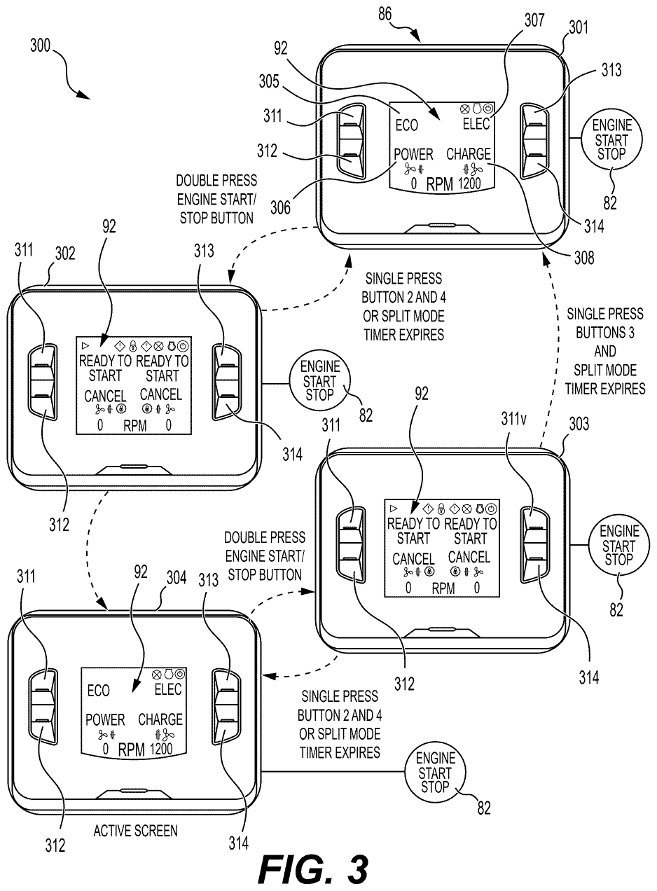

The operator control station 74 may also include an interactive user interface 86. The interactive user interface may include one or more inputs 90 and one or more displays 92 for displaying information related to the operation of the marine propulsion system 10. The one or more inputs 90 may be any type of input device(s). For example, the inputs may include one or more buttons, such as buttons 311-314 as described in FIG. 3. The one or more displays 92 may also be any type of known display device(s). In some embodiments, one or more of the inputs 90 and one or more of the displays 92 may be combined into a single device, such as for example, a touchscreen or the like. The one or more displays 92 may be configured to display a variety of information related to the operation of the marine propulsion system 10, such as for example, the power/torque/speed output percentage of the first and second power sources 18, 28, the power/torque/speed output percentage of the first and second motor-generators 20, 30, the operating mode the marine propulsion system 10 is currently in, various operational parameters, limits, alarms, and warnings, and any other useful information to be displayed to the operator. The inputs 90 may be configured for a variety of functions, such as for example, to allow an operator to select an operational mode or respond to the information being provided.

The propulsion control unit 76 is configured to control and monitor the operation of the marine propulsion system 10. The propulsion control unit 76 may be configured in a variety of ways. In the illustrated embodiment, the propulsion control unit 76 includes a controller 94 and a memory 96. The controller 94 may embody a single microprocessor or multiple microprocessors configured to receive signals from the various components of the marine propulsion system 10. A person of ordinary skill in the art will appreciate that the propulsion control unit 76 may additionally include other components and may also perform other functions not described herein. The controller 94 may also be configured to receive inputs from operator control station 74. The memory 96 may be a read only memory (ROM) for storing a program or programs, a random access memory (RAM) which serves as a working memory area for use in executing the program(s) stored in the memory 96, or a combination thereof. Alternatively, the memory 96 may be external to the controller 94 and the control unit 76.

The propulsion control unit 76 may be used to operate the marine propulsion system 10 in a plurality of operating modes. The controller 94 may be communicatively coupled to various portions of the marine propulsion system 10 to send signals to, and receive signals from, those portions. For example, FIG. 1 illustrates the controller 94 communicatively coupled to the first power source 18 and the second power source 28 by lines 100, to the first gearbox 24 and the second gearbox 34 by lines 102, and to the operator control station 74, the first bi-directional rectifier-inverter 64, and the second bi-directional rectifier-inverter 66 by lines 104.

The controller 94 is configured to operate the marine propulsion system 10 in a plurality of different operating modes, including: (i) a full engine mode, whereby first propulsion device 26 is driven by first power source 18 and second propulsion device 36 is driven by second power source 28; (ii) a split engine mode, whereby the first propulsion device 26 is driven by the first power source 18 and the second propulsion device 36 is idle, or the second propulsion device 36 is driven by the second power source 28 and the first propulsion device 26 is idle; ; (iii) an electric mode, whereby the first propulsion device 26 is driven by the first motor-generator 20 and the second propulsion device is drive by the second motor-generator 30; (iv) an eco-mode configured to maximize fuel efficiency, whereby the first propulsion device 26 is selectively driven by the first power source 18 or the first motor-generator 20 and the second propulsion device is selectively driven by the second power source 28 or the second motor-generator to complete a predetermined route with optimal fuel efficiency; (v) a power mode configured to temporarily maximize thrust, whereby the first propulsion device 26 is selectively driven by the first power source 18 and the first motor-generator 20 and the second propulsion device is selectively driven by the second power source 28 and the second motor-generator 30 to complete a predetermined maneuver with maximum power; and (vi) a charge mode configured to maximize battery charge available after a route is completed, whereby the first propulsion device 26 is selectively driven by the first power source 18 or the first motor-generator 20 and the second propulsion device is selectively driven by the second power source 28 or the second motor-generator to complete a predetermined route with optimal battery charge remaining. Other modes may also be engaged, such as a firefighting (“fifi”) mode, a warm mode, a combination (“combi”) mode, and a standby mode, where the combi mode is a combination of electric and warm modes.

The operator control station 74 may be configured to encourage use of the modes described above that are most fuel efficient at a given time or under a particular load or power requirement and include use of the electric mode or the “hybrid” modes, e.g.,, the modes in which the controller 94 sends signals to selectively drive the first propulsion device 26 by the first power source 18 or the first motor-generator 20 and selectively drive the second propulsion device 36 with the second power source 28 and the second motor-generator 30, which may include, for example, any of fifi mode, eco-mode, power mode, or charge mode.

### INDUSTRIAL APPLICABILITY

The disclosed aspects of the marine propulsion system 10 of the present disclosure may be used in a wide variety of marine applications. While the exemplary embodiments of the marine propulsion system 10 are illustrated as a dual driveline, parallel propulsion system, it will be understood that inventive aspects of the disclosed marine propulsion system 10 may be used in propulsion systems having more than or less than two driveline assemblies and other than parallel arrangements.

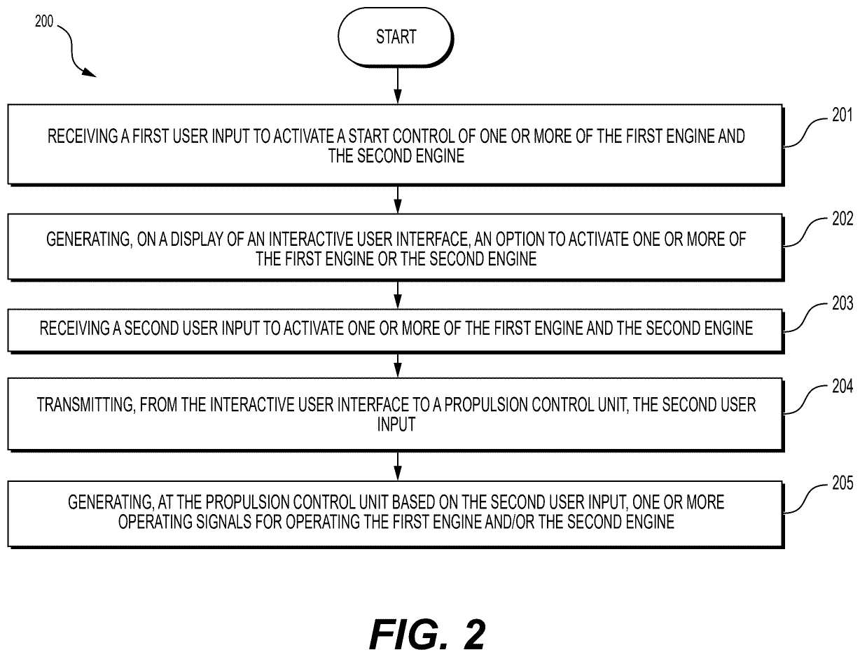

Referring to FIGS. 2 and 3 in tandem, an exemplary method 200 for operating the marine propulsion system 10 is described, with reference to user interfaces displayed on the operator control station 74. FIG. 2 provides a flowchart depicting an exemplary method 200 for operating the marine propulsion system 10, according to aspects of the disclosure, and FIG. 3 illustrates a flow diagram 300 of exemplary displays 92 displayed on the interactive user interface 86, according to aspects of the disclosure.

At the start of the method 200, the drive of the propulsion marine vessel may be in a standby mode or engine mode. At 301 of the flow diagram 300, the interactive user interface 86 indicates one or more modes of operation selectable by the user. For example, a first portion 305 of the display 92 indicates an “eco” mode, selectable by a user by pressing button 311. As indicated at portion 306 of the display 92, a user may initiate a power mode by pressing button 312. Likewise, a user may select an electric mode as indicated at portion 307 of the display 92 by pressing button 313, or select a charge mode as indicated at portion 308 by pressing button 314. The modes displayed on the display 92 during a default operation do not include engine-only modes to encourage hybrid or electric-only operation. This may be referred to as a hybrid mode display and only includes hybrid and electric-only modes. To enter an engine-only mode, a user must access engine start/stop button 82. Engine start/stop button 82 may be positioned on a reverse side of interactive user interface 86 from display 92.

At block 201, the method 200 may include receiving a first user input to activate a start control of one or more of the first engine and the second engine. This first input may be a single press or a double press of the engine start/stop button 82. A double press may be required so as to ensure the prevention of an accidental press being interpreted as a request to start an engine. As disclosed above, the engine start/stop button 82 may be a parity switch, with, for example, line 84 having a normally open contact and line 85 having a normally closed contact.

At block 202, the method 200 may include generating, on the display 92 of the interactive user interface 86, an option to activate one or more of the first engine or the second engine. Based on the user's pressing of the engine start/stop button 82, the display 92 may transition to displaying an engine mode activation display as shown at 302 of FIG. 3, the engine mode activation display replacing the hybrid mode display and including text indicative of an option to start the engines in portion 305 and portion 307 of the display 92. For example, the text may indicate “Ready to Start” and portion 305 may represent the first, or port side, engine, and portion 307 may represent the second, or starboard side, engine. Additionally, the display 92 may also display text indicative of an option to abort the starting of the engine(s) in portion 306 and portion 308 of the display.

At block 203, the method 200 may include receiving, at the display 92 of the interactive user interface 86, the second user input to activate one or more of the first engine and the second engine. Selecting button 311 may indicate a user's request to start the port side engine, while selecting button 313 may indicate a user's request to start the starboard side engine. Selecting both button 311 and button 313 will send a request to start both engines, requesting a full-engine mode operation. Selecting only one of button 311 and button 313 will send a request to start a split-mode operation where only one of the two engines is activated. Selecting button 312 may cancel the starting of the port side engine, and selecting button 314 may cancel the starting of the starboard side engine. Alternatively, the display 92 may include a timer with a predetermined expiration time, and upon a lapsing of the expiration time without receiving the user input to initiate a split mode or a full-engine mode, the option to initiate a split mode or full-engine mode expires and the interactive user interface returns to the hybrid mode display shown at 301.

At block 204, the method 200 may include transmitting, from the interactive user interface 86 to the propulsion control unit 76, the second user input. The second user input may be transmitted via signal lines 104 to propulsion control unit 76. The propulsion control unit 76 may be communicatively coupled to various portions of the marine propulsion system 10 to send signals to, and receive signals from, those portions. For example, FIG. 1 illustrates the controller 94 of propulsion control unit 76 communicatively coupled to the first engine (first power source 18) and the second engine (second power source 28) by lines 100.

At block 205, the method 200 may include generating, at the propulsion control unit 76 based on the second user input, one or more operating signals for operating the first engine or the second engine. The method 200 may also include signals to disengage the first clutch 22 or the second clutch 32 from the first motor-generator 20 and the second motor-generator 30, respectively.

At 304 of the flow diagram 300, the display 92 is shown after the engine mode or split-mode has been engaged. The display 92 returns to the hybrid mode display shown in 301, allowing the user to select one of the default modes, e.g., eco mode, power mode, electric mode, or charge mode. Double pressing engine start/stop button 82 returns the display 92 to the engine mode activation display shown in 302, allowing the user to switch from a split mode to a full engine mode if desired. Single pressing either of button 312 or button 314, or allowing the timer to expire, will return the display 92 to the hybrid mode display shown in 303.

At the start of the method 200, the drive of the propulsion marine vessel may be in a standby mode or engine mode. If the actual operation mode is any mode other than standby mode or engine mode, a single press or a double press of the engine start/stop button 82 starts both first power source 18 and second power source 28, putting the marine vessel 12 in engine mode.

In the illustrated embodiment of the marine propulsion system 10, the first driveline assembly 14 and the second driveline assembly 16 may be operated in a variety of modes that allow for optimal flexibility and reduced fuel consumption, reduced engine noise, and reduced operational time of the power sources (e.g., diesel engines). To this end, the marine propulsion system 10 includes a first driveline assembly that includes a first power source and a first motor-generator, each able to drive a first propulsion device either independently or in tandem, and a second driveline assembly that includes a second power source and a second motor-generator, each able to drive a second propulsion device either independently or in tandem. Furthermore, in the illustrated embodiment of the marine propulsion system 10, a user may have the option to select an engine-only mode or a split engine mode.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A propulsion system for a marine vessel, comprising:
a first driveline assembly, comprising:
a first engine;
a first motor; and
a first propulsion device configured to be driven by the first engine or the first motor;
a second driveline assembly, comprising:
a second engine;
a second motor; and
a second propulsion device configured to be driven by the second engine or the second motor;
a control station comprising:
an interactive user interface; and
an engine mode activator switch; wherein
a user interaction with the engine mode activator switch initiates an engine mode activation display on the interactive user interface, the engine mode activation display including an option to initiate a split engine mode operation whereby: (i) the first propulsion device is driven by the first engine and the second propulsion device is idle; or (ii) the second propulsion device is driven by the second engine and the first propulsion device is idle.

2. The propulsion system of claim 1, wherein the engine mode activator switch is a tactile button, and the user interaction with the engine mode activator switch is a double press of the tactile button.

3. The propulsion system of claim 1, wherein the interactive user interface includes a hybrid mode display including a plurality of options for:
activating the first propulsion device to be driven by the first motor;
activating the first propulsion device to be driven by a combination of the first motor and the first engine;
activating the second propulsion device to be driven by the second motor; and
activating the second propulsion device to be driven by a combination of the second motor and the second engine.

4. The propulsion system of claim 3, wherein the hybrid mode display is a default display for the interactive user interface, and the user interaction with the engine mode activator switch replaces the hybrid mode display with the engine mode activation display.

5. The propulsion system of claim 3, wherein the engine mode activation display includes a timer with a predetermined expiration time, and upon a lapsing of the expiration time without receiving a second user input to initiate a split mode, the option to initiate a split mode expires and the interactive user interface returns to the hybrid mode display.

6. The propulsion system of claim 1, wherein a user interaction with the engine mode activator switch initiates an engine mode activation display on the interactive user interface, the engine mode activation display includes an option to engage in a full engine mode whereby the first propulsion device is driven by the first engine and the second propulsion device is driven by the second engine.

7. The propulsion system of claim 1, wherein upon initiating the split engine mode operation, a hybrid mode operation display is displayed on the interactive user interface.

8. The propulsion system of claim 1, wherein the first motor includes a generator, and the second motor includes a generator.

9. A user interactive interface for a propulsion system of a marine vessel comprising a first propulsion device and a second propulsion device, the user interactive interface comprising:
a display;
an activator switch; and
one or more buttons configured to select options generated on the display; wherein a user interaction with the activator switch initiates an engine mode activation display on the display, the engine mode activation display including an option to initiate a split engine mode operation whereby: (i) the first propulsion device is driven by a first engine and the second propulsion device is idle; or (ii) the second propulsion device is driven by a second engine and the first propulsion device is idle.

10. The user interactive interface of claim 9, wherein the activator switch is a tactile button, and the user interaction with the activator switch is a double press of the tactile button.

11. The user interactive interface of claim 9, wherein the display defaults to a hybrid mode display including a plurality of options for:
activating the first propulsion device to be driven by a first motor;
activating the first propulsion device to be driven by a combination of the first motor and the first engine;
activating the second propulsion device to be driven by a second motor; and
activating the second propulsion device to be driven by a combination of the second motor and the second engine.

12. The user interactive interface of claim 11, wherein the user interaction with the activator switch replaces the hybrid mode display with the engine mode activation display.

13. The user interactive interface of claim 11, wherein the engine mode activation display includes a timer with a predetermined expiration time, and upon a lapsing of the expiration time without receiving a second user input to initiate a split mode, the option to initiate a split mode expires and the interactive user interface returns to the hybrid mode display.

14. The user interactive interface of claim 11, wherein the first motor includes a first generator, and the second motor includes a second generator.

15. The user interactive interface of claim 9, wherein a user interaction with the activator switch initiates an engine mode activation display on the interactive user interface, the engine mode activation display includes an option to engage in a full engine mode whereby the first propulsion device is driven by the first engine and the second propulsion device is driven by the second engine.

16. The user interactive interface of claim 9, wherein upon initiating the split engine mode operation, a hybrid mode operation display is displayed on the interactive user interface.

17. A method for controlling operations of a marine vessel having a first engine and a second engine operable to propel the marine vessel, the method comprising:
receiving a first user input to activate a start control of one or more of the first engine and the second engine;
generating, on a display of an interactive user interface, an option to activate one or more of the first engine and the second engine;
receiving, at the display of the interactive user interface, a second user input to activate one or more of the first engine and the second engine;
transmitting, from the interactive user interface to a propulsion control unit, the second user input; and
generating, at the propulsion control unit based on the second user input, one or more operating signals for operating the first engine or the second engine.

18. The method of claim 17, wherein the option to activate one or more of the first engine and the second engine includes a timer with a predetermined expiration time, and:
upon a lapsing of the expiration time without receiving the second user input to activate one or more of the first engine and the second engine, the option to activate one or more of the first engine and the second engine expires.

19. The method of claim 17, wherein the first input is received at an engine mode activator button.

20. The method of claim 17, wherein the option to activate one or more of the first engine and the second engine includes an option to activate one of the first engine and the second engine and cancel activation of the other of the first engine and the second engine.
